(19) United States
(12) Patent Application Publication
(10) Pub. No.: US 2007/0105672 A1
(43) Pub. Date: May 10, 2007

(54) Variable speed transmission

(76) Inventor: Daren Luedtke, Macomb, MO (US)

Correspondence Address: Dean D. Small;THE SMALL PATENT LAW GROUP LLP, SUITE 1611, 611 OLIVE STREET, SAINT LOUIS, MO, 63101, US

(21) Appl. No.: 11/580,492

(22) Filed: Oct. 13, 2006

Related U.S. Application Data
(60) Provisional application No. 60/727,958, filed on Oct. 18, 2005.

(51) Int. Cl. F16H 55/56; F16H 9/16

(52) U.S. Cl. 474/33; 474/8

(57) ABSTRACT

A variable speed transmission is provided that includes a first variable speed drive pulley and a second variable speed drive pulley. A pitch diameter of the first variable speed drive pulley and the second variable speed drive pulley are configured in an opposed arrangement.

### CROSS REFERENCE TO RELATED APPLICATIONS

This application claims priority to and the benefit of the filing date of U.S. Provisional Application No. 60/727,958, filed on Oct. 18, 2005, entitled “Regeneratively Charged Electric Vehicle,” which is hereby incorporated by reference in its entirety.

### BACKGROUND OF THE INVENTION

This invention relates generally to systems for power transmission from a drive source to a driven element, and more particularly, to a transmission system including a drive train for electric vehicles (EVs).

EVs typically include one or more rechargeable power supplies, for example, battery packs, for storage of electric power. The stored electric power may be used to power a drive motor to propel the vehicle and several electronic elements used to control the vehicles performance and safety while being driven. For example, known EVs typically include a motor controller that not only provides the amperage required by the motor to move the vehicle (e.g., power from the battery pack to the motor), but also monitors the flow of that power and other aspects of motor performance, such as the ohms reading from a potentiometer. If a reading is out of a predetermined and/or preprogrammed value range, then for example, the logic portion of the motor controller shuts off the power portion of the motor controller, thereby turning off the power to the motor and bringing the vehicle to rest until the condition (e.g., performance abnormality) is corrected. Once the condition is corrected the motor controller resumes normal operating power functions, for example, according to the drivers input with a potentiometer that usually operates in conjunction with the foot feed, comm only referred to as the “gas pedal” of the vehicle.

The controlled movement of the vehicle is dependant upon the depression of the driver's foot on the foot feed that in turn varies the position of the potentiometer control arm and that also varies the amount of resistance (e.g., ohms) input into the motor controller. The motor controller then continually calculates and regulates to the motor the necessary amperage and voltage needed from the battery pack to accelerate the vehicle or maintain the speed of travel. The other electrical devises in the system safely control the power supply, and include, for example, a main contactor, fuses or circuit breakers, and a reverse contactor with switch (e.g., a single pole, double throw switch). The switch controls the movement of the motor, for example, in a first switch position allowing the motor to move clockwise to thereby move the vehicle in a forward direction, and in a second switch position reverses the polarity of the motor through the reverse contactor allowing the motor to move in the opposite direction of rotation (counter-clockwise) thereby allowing the vehicle to move in reverse.

Further, a DC to DC converter is also typically used to supply power to the accessories in the vehicle that draws amperage from the same battery pack that is used to power the drive system for the vehicle. This further reduces the amount of available battery power and the maximum travel distance for a conventional EV. Thus, EVs have a substantially lower amount of available travel distance compared to a vehicle using an internal combustion engine that includes a supply of gasoline or diesel. For example, a typical gasoline powered automobile can travel three to four hundred miles on a tank of fuel and takes only a few minutes to refuel. However, the average EV only typically travels not more than about one hundred miles per battery charge and takes six to eight hours to recharge. This limited travel distance and lengthy time needed to recharge results in the unpopularity and lack of demand for EVs.

### BRIEF DESCRIPTION OF THE INVENTION

In one embodiment, a variable speed transmission is provided that includes a first variable speed drive pulley and a second variable speed drive pulley. A pitch diameter of the first variable speed drive pulley and the second variable speed drive pulley are configured in an opposed arrangement.

In another embodiment, a variable speed transmission is provided that includes a first pulley and a second pulley. The variable speed transmission further includes a plurality of variable speed drive pulleys between the first and second pulleys.

In yet another embodiment, a variable speed transmission is provided that includes a first variable speed drive pulley, a second variable speed drive pulley and a third variable speed drive pulley.

### BRIEF DESCRIPTION OF THE DRAWINGS

FIG. 1 is a block diagram of a variable speed drive system constructed in accordance with an embodiment of the invention.

FIG. 2 is a top plan view of a variable speed drive system constructed in accordance with an embodiment of the invention.

FIG. 3 is top plan view of the mechanical components of VSD system constructed in accordance with an embodiment of the invention with a cut away sectional view of the belts and showing a low speed configuration.

FIG. 4 is top plan view of the mechanical components of VSD system constructed in accordance with an embodiment of the invention with a cut away sectional view of the belts and showing a high speed configuration.

FIG. 5 is a side elevation view of the VSD system shown in FIG. 2.

FIG. 6 is a side elevation view of the VSD system shown in FIG. 3.

FIG. 7 is a top perspective view of a VSD system constructed in accordance with an embodiment of the invention.

FIG. 8 is a top plan cut away view of a vehicle having a VSD system constructed in accordance with an embodiment of the invention.

FIG. 9 is a block diagram of the various components connected to a VSD system constructed in accordance with an embodiment of the invention.

FIG. 10 block diagram of a low voltage motor control subsystem constructed in accordance with an embodiment of the invention.

FIGS. 11A-11B is table illustrating a finite preprogramming sequence for a programmable logic computer (PLC) in accordance with an embodiment of the invention.

FIGS. 12A-12C is a table illustrating a variable preprogramming sequence for a programmable logic computer (PLC) in accordance with an embodiment of the invention.

FIG. 13 is a top plan cut away view of a train locomotive having a VSD system constructed in accordance with an embodiment of the invention.

FIG. 14 is a side elevation view of the train locomotive of FIG. 12 having the VSD system constructed in accordance with an embodiment of the invention.

### DETAILED DESCRIPTION OF THE INVENTION

As used herein, an element or step recited in the singular and proceeded with the word “a” or “an” should be understood as not to exclude plural elements or steps, unless such exclusion is explicitly recited. Furthermore, references to “one embodiment” or “an embodiment” of the present invention are not intended to be interpreted as excluding the existence of additional embodiments that also incorporate the recited features.

Various embodiments of the invention provide an electric vehicle drive system that includes a Variable Speed Drive (VSD) system. The VSD system further generally includes electrical and mechanical components that may be used with a high voltage subsystem, a low voltage motor control subsystem, an electrical accessory subsystem and a regenerative charging system. The regenerative charging system includes a momentum regenerative charging system comprised of electrical and mechanical components that utilize the momentum of the vehicle to recharge the battery pack and an additional regenerative wind charging system including electrical and mechanical components capable of generating additional power to charge the vehicle's battery pack using the power of the wind at higher vehicle speeds.

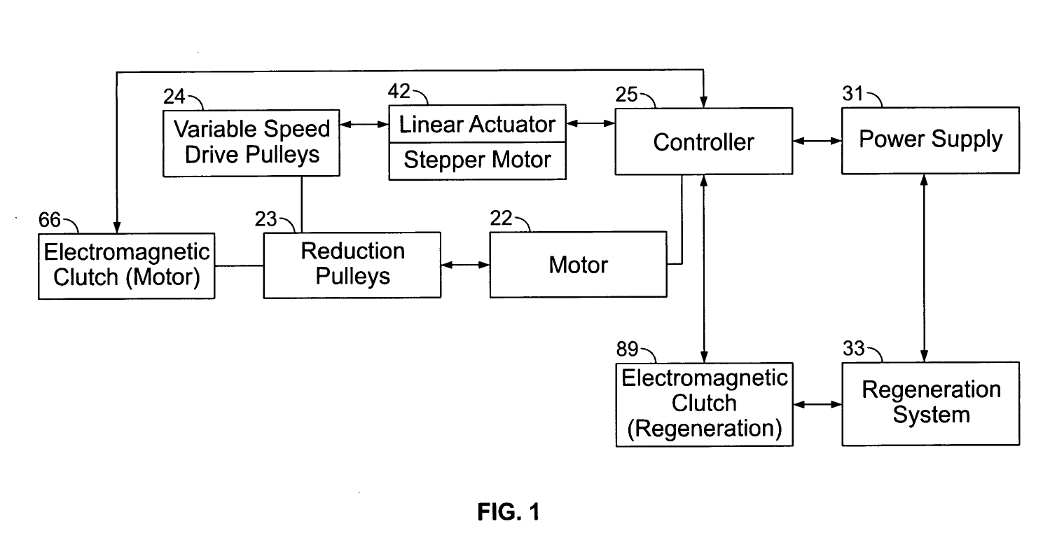

In general, and as shown in FIG. 1, a plurality of variable speed pulleys 24 are connected to a power source, such as, and electric motor 22. In one embodiment, one or more reduction pulleys 23 are provided between the motor 22 and the variable speed drive pulleys 24, for example, to provide a 2:1 ratio between the motor 22 and a first shaft, for example, a jack shaft (now shown), a 1:1 ratio between the first shaft and a second shaft, for example, a regeneration shaft (not shown) and a 2:1 ratio between the first shaft and the variable speed pulleys 24. A linear actuator 42 is connected to the variable speed drive pulleys 24, and more particularly, to one of the variable speed drive pulleys 24 that operates as the control pulley. A stepper motor 43 is connected to the linear actuator 42. A controller 25 that may include one or more processors or logic circuits is connected to the linear actuator 42. A first electromagnetic clutch 66 is configured to selectively engage and disengage the motor 22 from the variable speed drive pulleys 24. A second electromagnetic clutch 89 is configured to selectively engage and disengage a regeneration system 33 from a power supply 31. The power supply 31 may include one or more battery packs or subsystems as described in more detail herein.

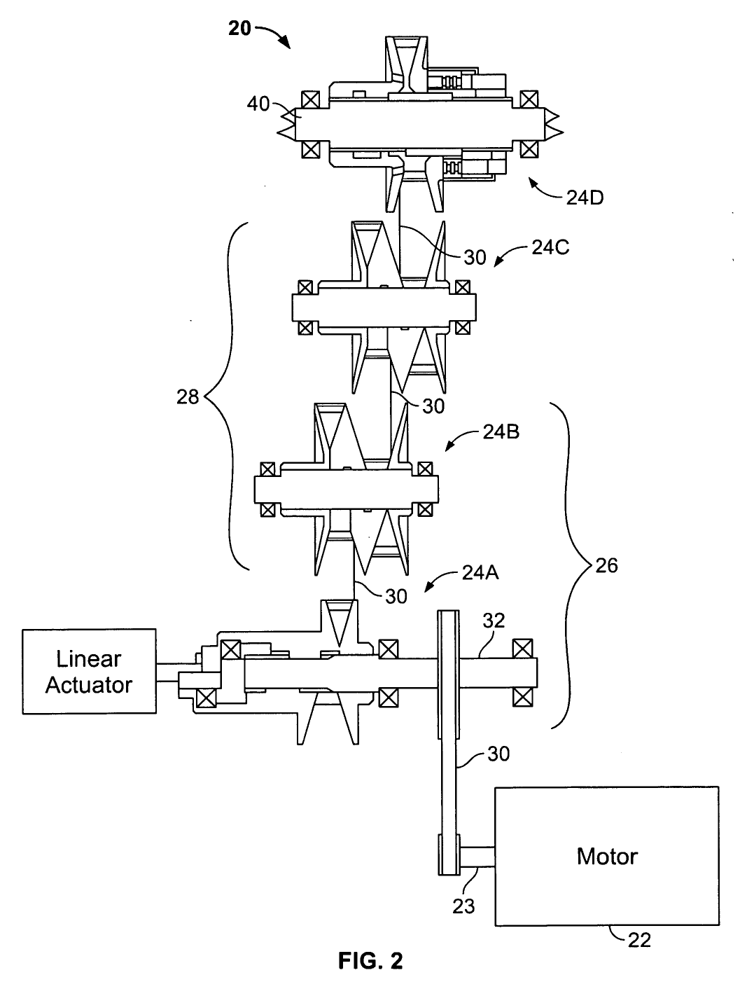

More particularly, as shown in FIG. 2, a VSD system 20 includes the plurality of pulleys 24 for conveying power from a power source 22 (e.g., electric drive motor) to, for example, an axle 40 of a vehicle. In particular, the plurality of variable speed drive pulleys 24A-24D are provided such that each pair of variable speed drive pulleys 24A-24D is configured in an opposed arrangement thereby forming multiple pairs of opposing variable speed drive pulleys 24A-24B, 24B-24C, 24C-24D. In particular, each pair of variable speed drive pulleys 24A-24-D may define a pitch diameter ratio providing different exponentially variable pitch/torque ratios from variable speed pulley 24A through variable speed pulley 24D. For example, a second variable speed drive pulley 24B of a first opposing pair 26 is coupled to the same shaft as a first variable speed drive pulley 24C of a second opposing pair 28. This opposing pair arrangement is repeated. The variable speed drive pulleys 24A-24D are linked via belts 30. The belts 30 have angled sides (e.g., angled at about eleven degrees) corresponding to the angled variable portions of the variable speed drive pulleys 24A-24D. It should be noted that when reference is made herein to a pulley 24, this refers to one or more of the pulleys 24A-24D.

Each of the variable speed drive pulleys 24A-24D may be configured differently. For example, the variable speed drive pulley 24A connected to the motor 22 via a belt 30 may be a control pulley coupled to a solid shaft 32. A plurality of variable speed drive pulleys 24B and 24C are then configured as idler pulleys between the control pulley 24A and a variable speed drive pulley 24D at the opposite end configured as a spring loaded slave pulley. Essentially, a plurality of variable speed idler pulleys 24B and 24C are positioned inline between a control pulley 24A and a slave pulley 24D. The variable speed idler pulleys 24B and 24C may be adjusted as is known to vary the pitch diameter or torque ratio of the VSD system 20.

It should be noted that the number of variable speed drive pulleys 24A-24D may be modified such that, for example, additional variable speed drive pulleys 24D, 24E, 24F, etc, (not shown) may be provided to generate additional exponentially multiplied pitch diameter/torque ratios between the motor 22 and the axle 40. The pitch diameter/torque ratios the of the variable speed drive pulleys 24A-24C are exponentially infinitely variable within the diametrical limits of the variable speed drive pulleys 24A-24D.

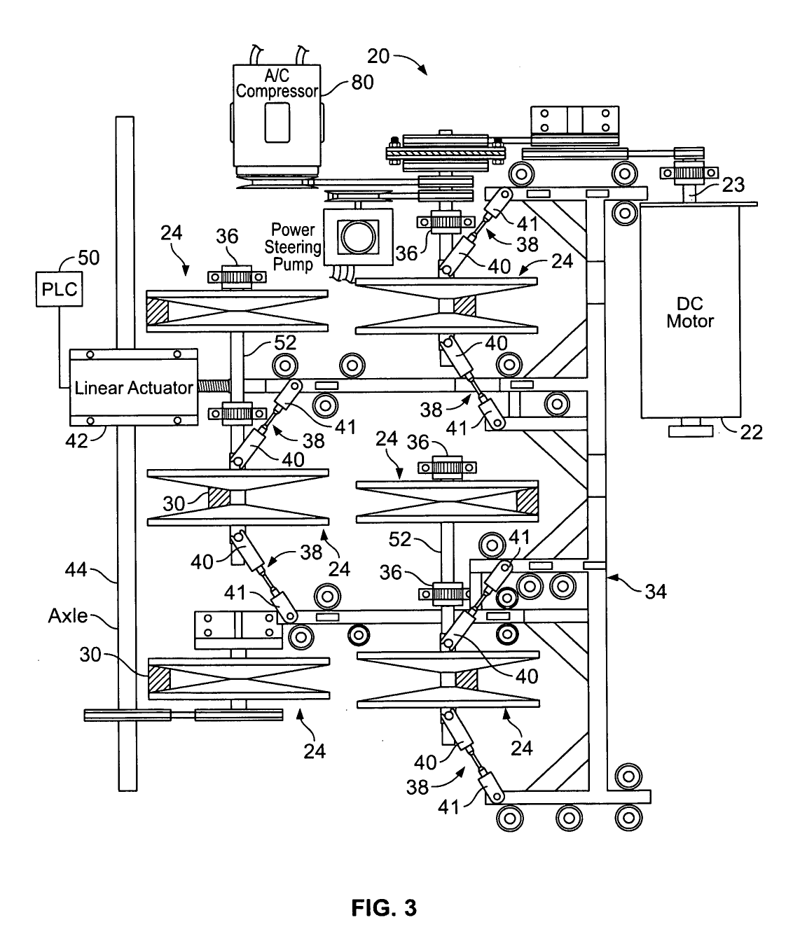

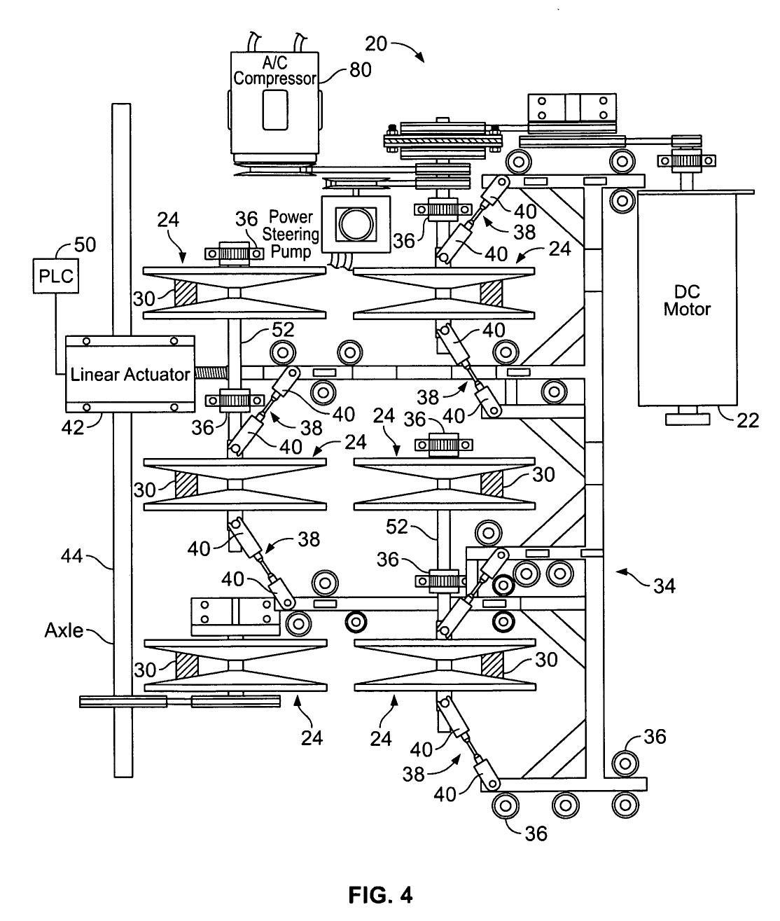

In operation, referring to FIGS. 3 and 4, the first variable speed drive pulley 24 of any given pair of pulleys is adjusted with a leverage system 34. FIG. 3 illustrates the VSD system 20 at a low speed (e.g., one mile per hour (MPH)) and FIG. 4 illustrates the VSD system at a higher speed (e.g., ninety MPH) In particular, the leverage system 34 is supported with appropriate bearing mounts 36 from the framework (not shown) of the VSD system 20 and linked to an opposing pair of throw-out bearings (not shown) abutting the adjacent outer surface of each adjustable half of each first variable speed drive pulley 24 of each pair of variable speed drive pulleys 24 by an adjustable linkage 38 and end forks 40 and 41. The linear actuator 42 shown above the axle 44 is operatively coupled to the leverage system 34 and electrically coupled to the controller 25 (shown in FIG. 1) and may be preprogrammed to move a predetermined distance per variable linear actuator input received from, for example, the controller 25, shown in FIGS. 3 and 4 as a programmable logic computer (PLC) 50 as described in more detail herein.

It should be noted that the linear actuator input may be computed by the PLC 50 from the inputs of several independent analog and digital devices along with preprogrammed tables and equations in the PLC 50 and further transmitted through the leverage system 34 to the opposing outermost sides of the adjustable first variable speed drive pulleys 24 of each pair of adjustable variable speed drive pulleys 24 with the pulley halves of the first pulleys 24 of each pair of pulleys 24 being spread apart to their outermost positions. In operation, starting in an “open” condition or position, with the leverage system 34 decreasing the distance between the movable halves of the first variable speed drive pulleys 24, thereby acting as the “master” pulley of the given pairs of first and second pulleys 24, and with the opposing second variable speed pulleys 24 of each pair of first and second pulleys 24 mechanically operated with a pair of opposingly adapted spring type devises (not shown) located on the outer opposing sides of the adjustable pulley halves, with the pulley halves being forced together in a “closed” condition. The drive belt 30 (shown in FIGS. 2 and 3 in a cut away sectional view) is adaptably mounted on and between each pair of variable speed pulleys 24 coupling each pair of first and second variable speed pulleys 24. The belts 30 are smaller in radial dimension around the first pulley 24 of each pair of first and second pulley 24, and the belt 30 is radially larger in dimension around the second pulley 24 of each pair of first and second pulleys 24.

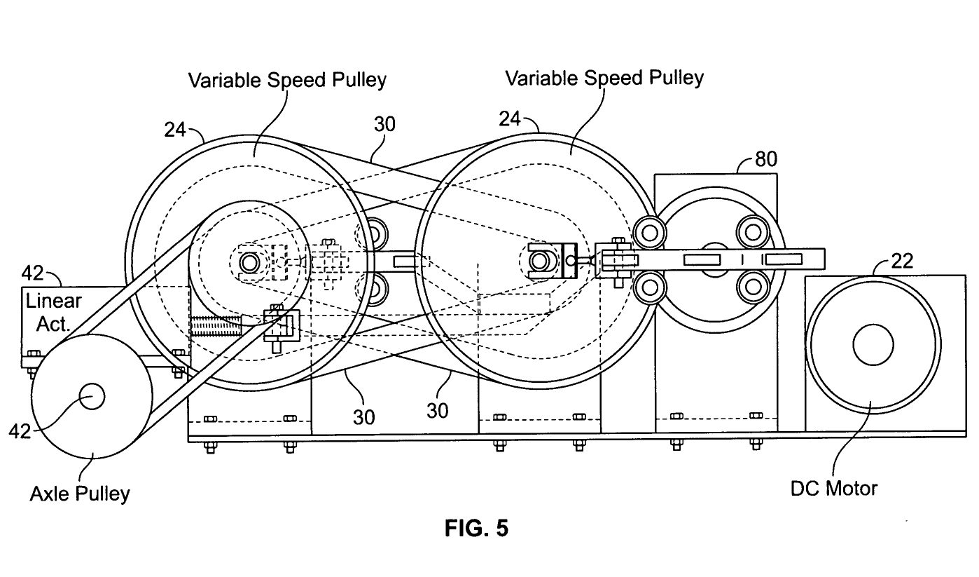

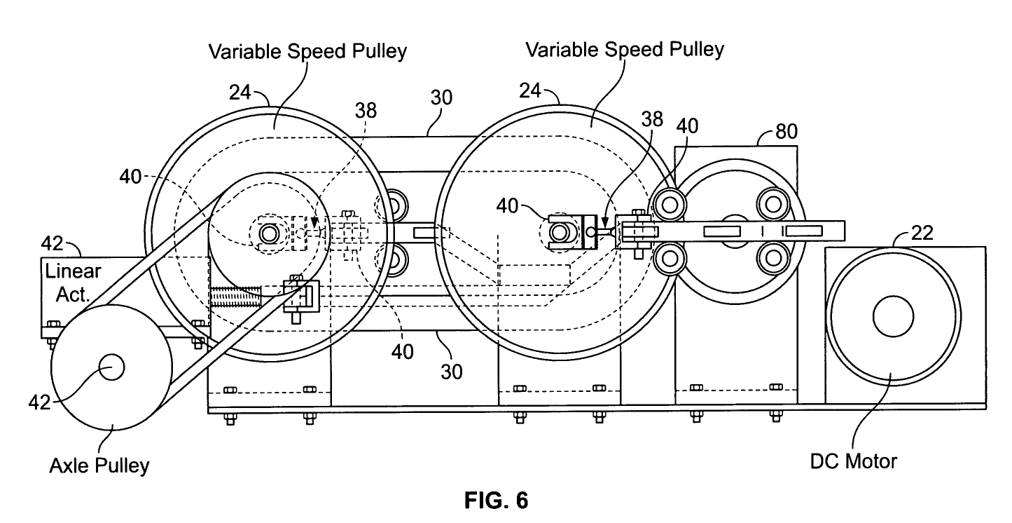

Accordingly, in operation, once movement of the linear actuator 42 and leverage system 34 is initiated, the inward movement of the adjustable halves of the first pulley 24 of each pair of opposing pulleys 24, and the mechanical spring type devices of the second pulleys 24 of each pair of opposing pulleys 24 forces the opposing second pulley 24 to “resist” the reactive movement created by the first “master” pulley, thereby acting as the second “slave” pulley of the first and second pulleys 24 of each pair of variable speed pulleys 24, maintaining belt tension between the first and second pulleys of each pair of opposing variable speed pulleys 24. Thus, the distance between the movable halves of the opposing second variable speed drive pulley 24 is inversely increased or decreased verses the distance between the halves of the first variable speed drive pulley 24 of each pair of opposing first and second pulleys 24 as shown in FIGS. 5 and 6 (FIG. 5 illustrating the VSD system 20 at a low speed and FIG. 6 illustrating the VSD system 20 at a higher speed), thereby inversely increasing or decreasing the radial dimension of the belt 30 riding in or out on each variable speed pulley 24. A plurality of infinitely inverse and variable positions is provided with the belt 30 riding on and between the halves of both the first and second pulleys 24 of each pair of pulleys 24 creating a plurality of infinitely variable torque ratios within the diametrical limits of each pair of first and second pairs of pulleys 24.

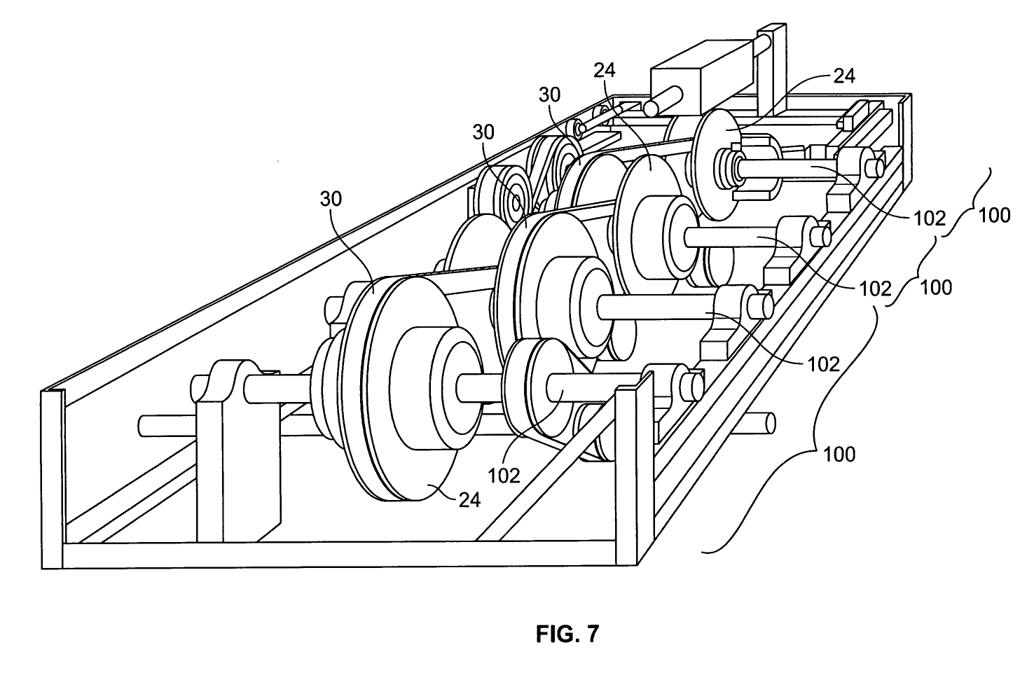

Referring again to FIGS. 3 and 4, one or more pairs of first and second variable speed drive pulleys 24 are provided such that the second “slave” pulley 24 of the first pair of pulleys 24 is adaptively coupled to the same transmitting shaft 52 as that of the first “master” pulley 24 of the second pair of pulleys 24. The second “slave” pulley 24 of the second pair of pulleys 24 also is adaptively coupled to the same transmitting shaft 52 as that of the first “master” pulley 24 of the third pair of pulleys 24 and so on, creating an exponentially reduced or increased torque ratio from the drive motor 22 through the multiple pairs of variable speed pulleys 24 and adapted vehicle drive train, resulting in a VSD drive train with an inverse and lower amperage draw ratio per MPH. Essentially a plurality of stages 100 of variable speed drive pulleys 24 is formed as shown in FIG. 7. Each variable speed drive pulley 24 rotates about an axle 102 and may also connect to other components or pulleys as described herein.

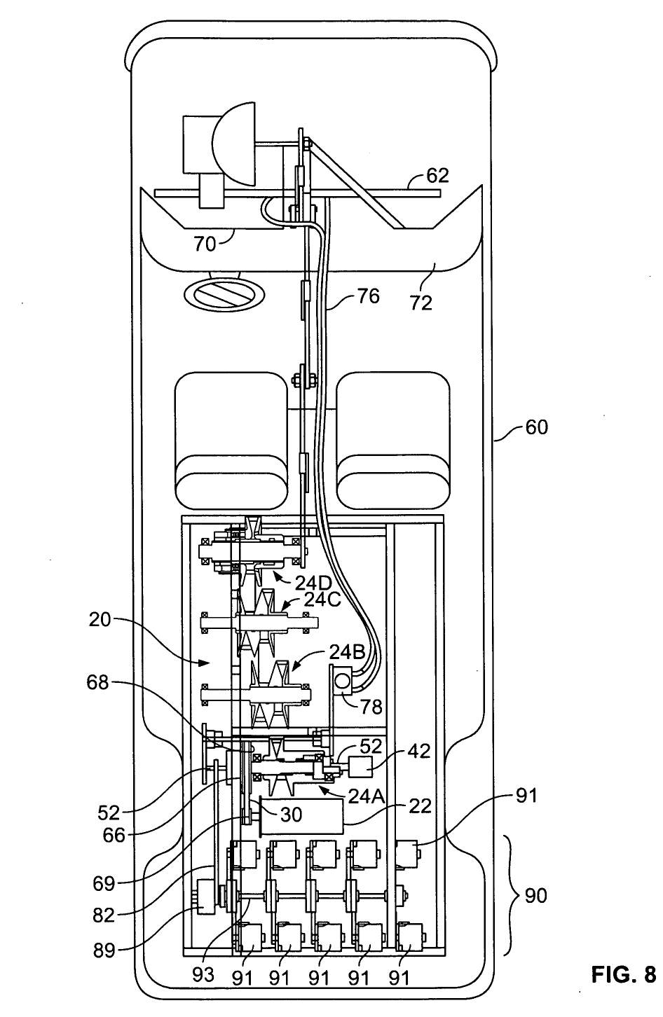

The VSD system 20 may be implemented in connection with a movable vehicle 60 (e.g., automobile, locomotive train, tractor, etc.), illustrated in FIG. 8 as a car. The vehicle 60 generally includes a front axle 62 and rear axle (not shown) with the front axle 62 connected to wheels of the vehicle 60. The vehicle 60 may include other known components, for example, a firewall 70, a dash board 72, and power steering hoses 76 connecting the front axle 62 to a power steering pump 78.

In this embodiment, the VSD system 20 may include one or more pairs of first and second variable speed drive pulleys 24 configured such that one of the first variable speed drive pulleys 24 of the pairs of variable speed drive pulleys 24 closest to the drive motor 22 is mounted on the same shaft 52 as the electromagnetic clutch 66 (also referred to as the motor electromagnetic clutch). The electromagnetic clutch 66 is adaptably coupled to, for example, a pulley 68, which may be one of the reduction pulleys 23 (shown in FIG. 1) with a belt 30 adaptably coupled to and mounted between the pulley 68 and a pulley 69 of the drive motor 22, with the pulley 68 of the electromagnetic clutch 66 and the pulley 69 of the drive motor 22 being adequately dimensioned in diametrical sizes to create the necessary pitch diameter reduction to engage the VSD system 20 when power is supplied to the motor 22 and electromagnetic clutch 66.

In the various embodiments, one of the second variable speed drive pulleys 24 of the pairs of variable speed drive pulleys 24 closest to the axle 40 or final drive system of the vehicle 60 is adapatbly mounted on the same shaft as an adequately sized final drive transfer pulley (not shown) with a belt adaptably mounted on and between the final drive transfer pulley and the final drive pulley to engage the final drive system of the vehicle 60 when power is supplied to the motor 22 and electromagnetic clutch 66 creating movement of the vehicle 60.

It should be noted that a plurality of shafts 52 may be adaptably mounted with suitable bearing configurations to the framework of the VSD system 20 as described herein and to support the various VSD system 20 components. Further, it should be noted that the one or more of the variable speed drive pulleys 24 may be connected to other accessories or devices within the vehicle 60. For example, one or more auxiliary pulleys may be adaptably mounted on a shaft 52 carrying the first pulley 24 of the one opposing pair of pulleys 24 closest to the drive motor 22 to couple (using a belt 30) to, for example, an air conditioning compressor 80 (shown in FIGS. 3 and 4) for the vehicle 60, the power steering pump 78 of the vehicle 60 or the vacuum pump (not shown) for the power brakes of the vehicle 60, etc.

The vehicle 60 also may include a regenerative or rechargeable power subsystem, for example, a momentum regeneration system 90 that may be part of the regeneration system 33 (shown in FIG. 1). In the various embodiments, the electromagnetic clutch 89 is adaptably coupled by a belt 82 to a momentum regeneration system 90 to activate and run the momentum regeneration system 90 while the vehicle 60 is in a deceleration condition with control of power provided by the PLC 50 (shown in FIGS. 3 and 4), as determined by the input from a speedometer 114 (shown in FIG. 10). The momentum regeneration system 90 and control thereof may be provided as described in co-pending U.S. patent application having attorney docket number SPLG 11750-1 and entitled “Power Regeneration System,” which is hereby incorporated by reference herein in its entirety.

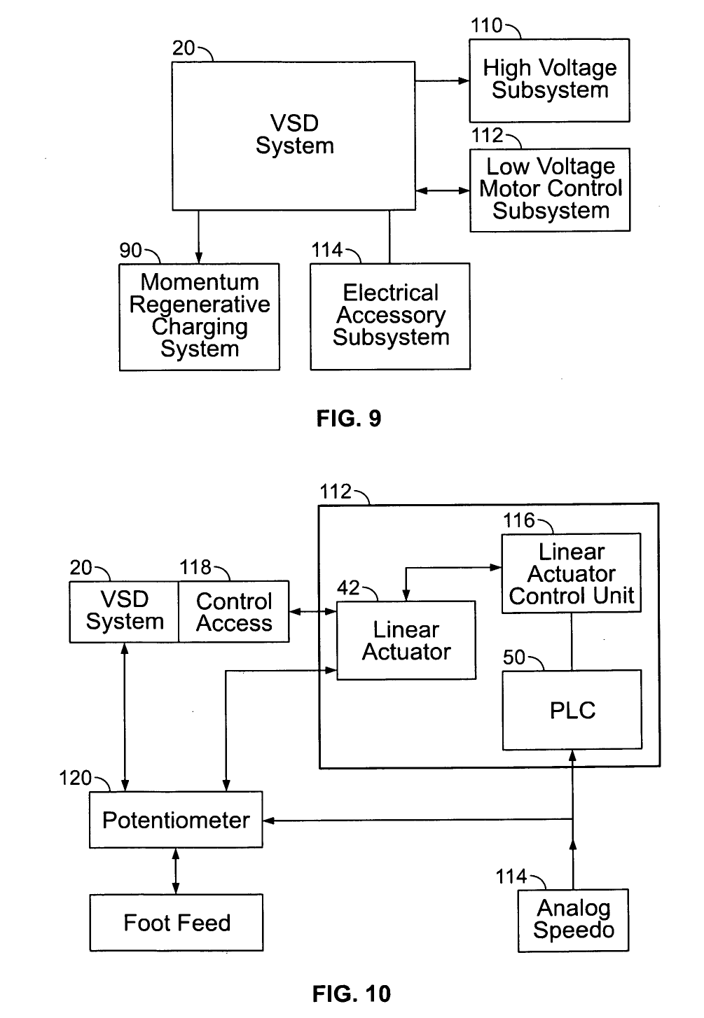

As shown in FIG. 9, the VSD system 20 generally includes electrical and mechanical components that may be used, for example, with a high voltage subsystem 110 to power the electric drive motor, a low voltage motor control subsystem 112 to control the variable speed transmission via the PLC 50 (shown in FIGS. 3 and 4) and necessary corresponding electromechanical components, an electrical accessory subsystem 114 to power and supply conventional accessories for the vehicle such as the horn, lights and wipers for example, and a regenerative charging system, such as the momentum regeneration system 90 that uses the momentum and relative wind energy generated through the movement of the vehicle to recapture what relative energy is created in the form of electrical regeneration of the battery packs in the vehicle. It should be noted that the power supply 31 (shown in FIG. 1) may include a plurality of rechargeable batteries that defining the subsystems. For example, a plurality of batteries may be wired in series to provide power to the motor 22, such as, ninety-six volts of power. A plurality of other batteries may be wired in series in twos and then in parallel to provide power (e.g., twelve volt power) to, for example, the electromagnetic clutches 66 and 89, different relays, computers, the stepper motor 43, etc. Additionally, the electrical accessory subsystem 114 may include a standard twelve volt vehicle battery as is known. It should be noted that the various batteries may be combined or configured in different arrangements.

More particularly, and referring to the low voltage motor control subsystem 112, the linear actuator 42 that controls the VSD system 20 is connected to a linear actuator control unit 116, for example, the stepper motor 43 (shown in FIG. 1) that is also connected to the PLC 50 as shown in FIG. 10. The input into the linear actuator control unit 116 from the PLC 50 controls the movement of the linear actuator 42, for example, by predetermined segments to various preprogrammed positions at preprogrammed various rates of speed. The linear actuator 42 is mechanically coupled to a control arm 118 for the variable speed pulleys 24 with the control arm 118 adaptably coupled to throw-out bearings that are adaptably abutted to the outer sides of one of the two variable speed pulleys 24 for all of the opposing variable speed pulleys 24 (shown in FIGS. 1 through 6). Essentially, a single control arm 118 is connected to all the pulleys 24A-24D. Thus, when the linear actuator 42 moves based on a control signal from the linear actuator control unit 116 as controlled by the PLC 50, the control arm 118 moves, which in turn moves the throw-out bearing in or out and in turn moves, for example, a movable side half of the abutted pulley 24 in or out (with one of the side halves of each pulley 24A-24D being fixed). Thus, the pitch ratio between the drive motor 22 and the axle 40 are changed, thereby changing the speed of the vehicle 60.

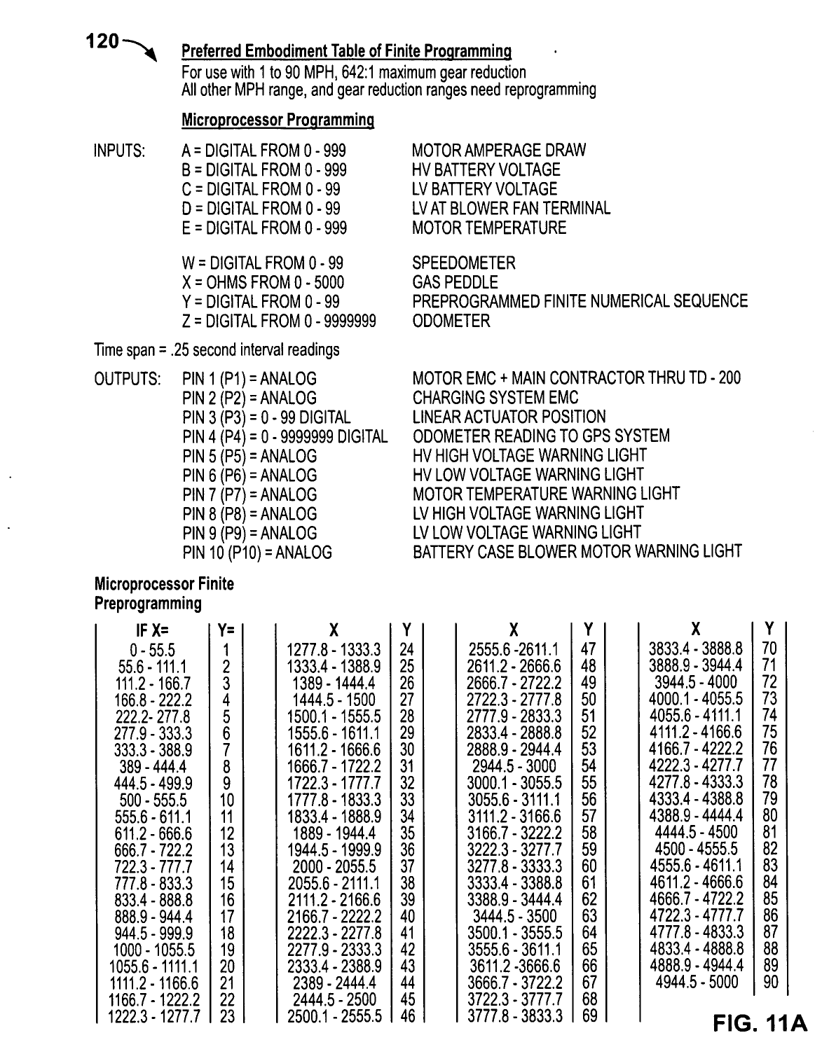

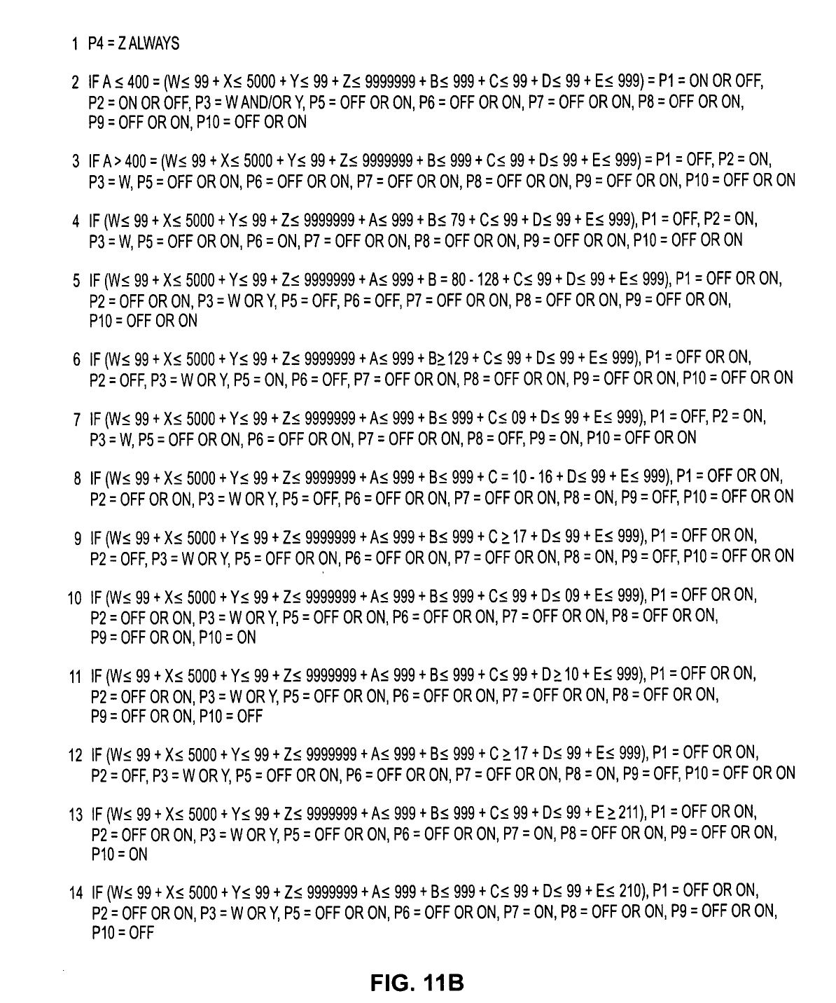

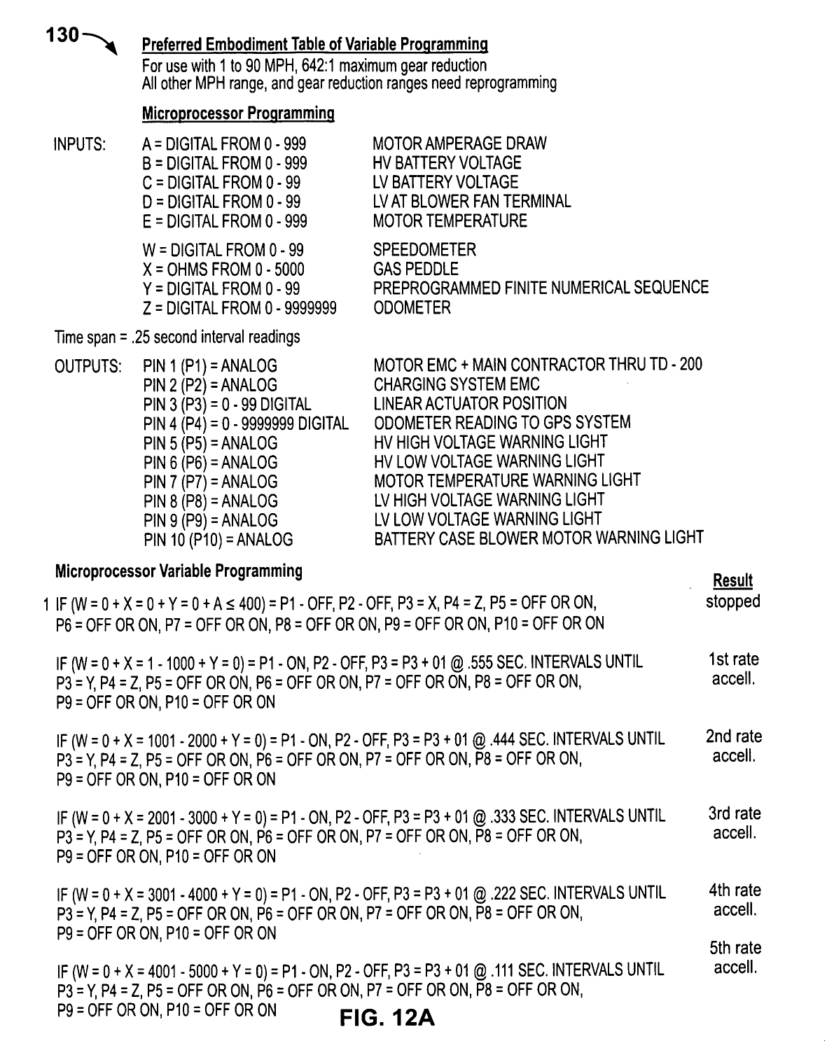

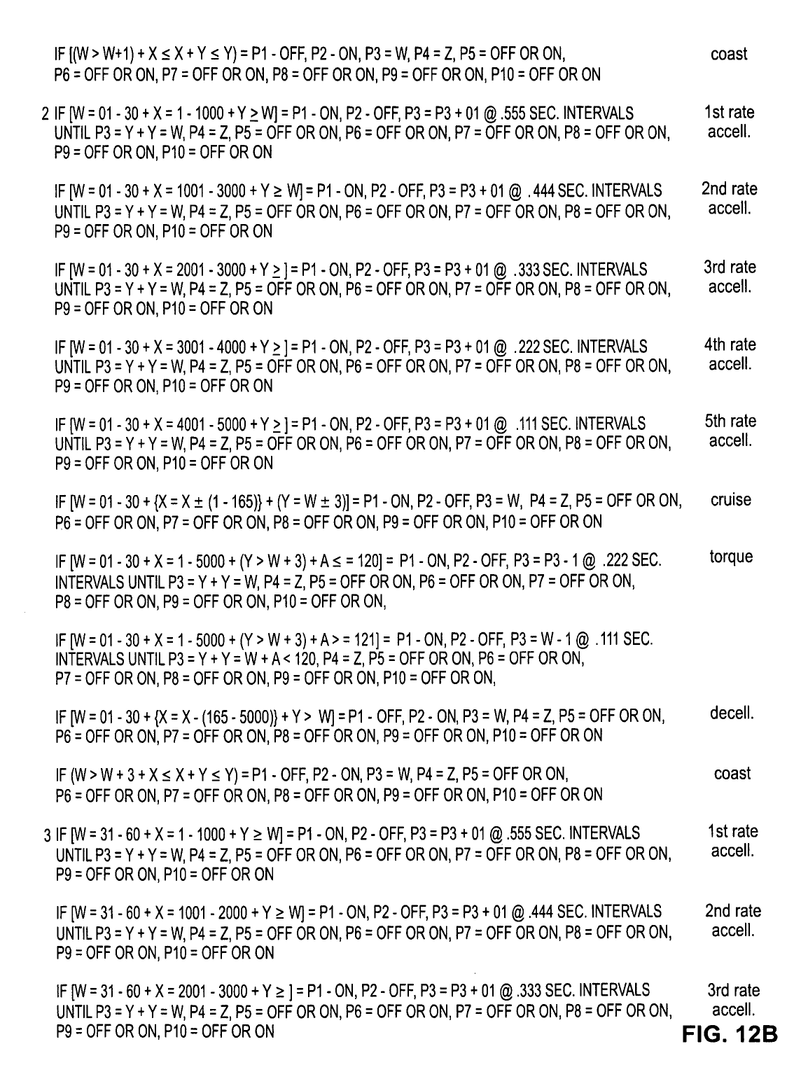

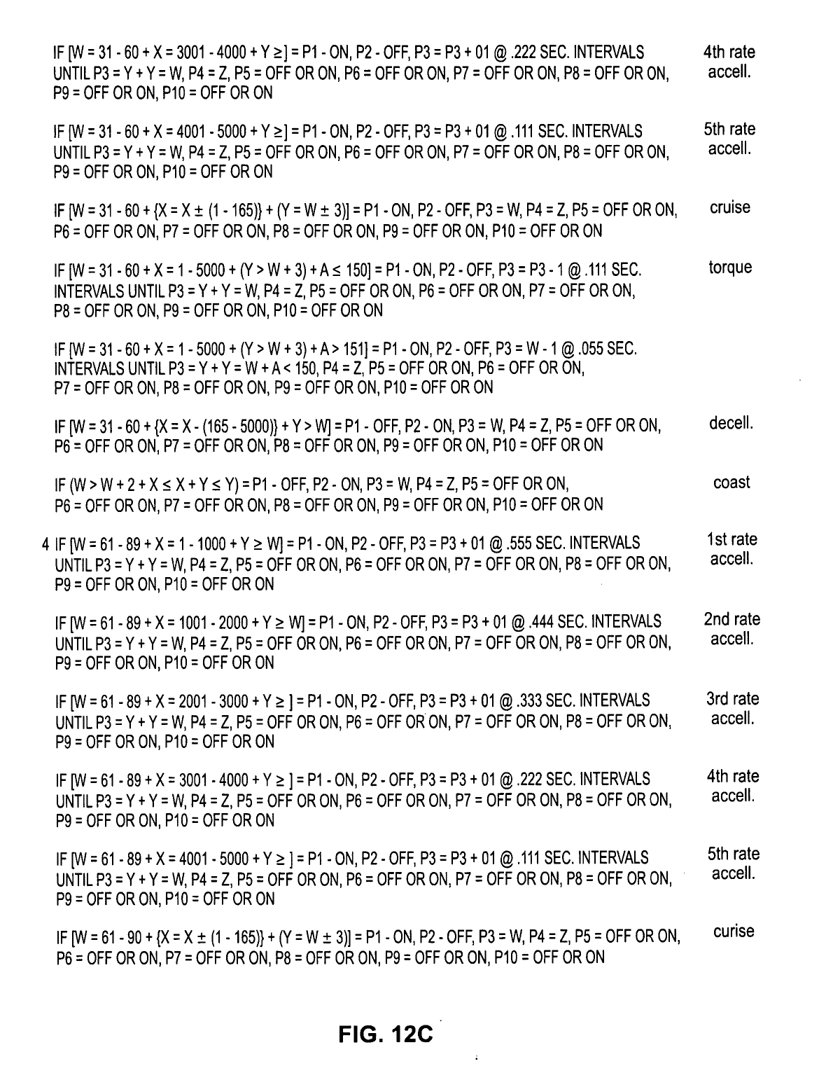

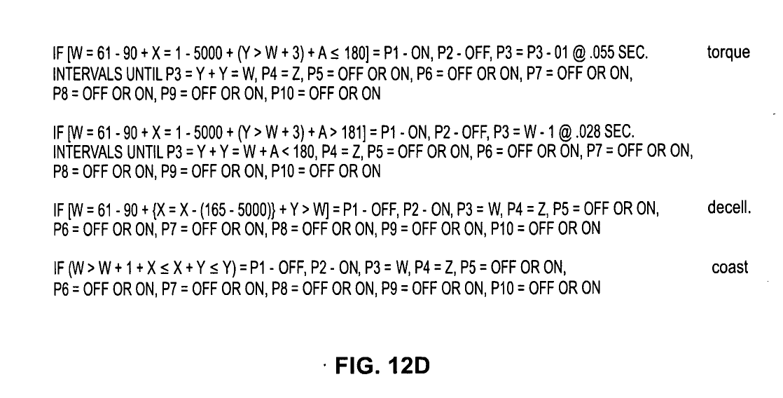

The PLC 50 may be preprogrammed in different manners to control the operation of the VSD system 20, and more particularly, the settings for each of the stages 100 (shown in FIG. 7) formed by opposing variable speed pulleys 24. For example, a finite preprogramming sequence 120 as shown in FIG. 11 (11A-11B) may be provided to automatically shut the entire variable speed drive system down for reasons of safety. For example, if one or more of the finite programs varies to the point in which the reading falls outside of the preprogrammed finite range, the PLC 50 automatically shuts the variable speed drive system off until the condition is corrected. Referring to at FIG. 11, for example, with “A” being the motor amperage draw, line 2 of the finite programming states that if the amperage draw is 400 amps or below, the vehicle is in a “safe” condition and the PLC can have pins 1 through 10 in an on or off condition. Line 3 of the finite programming states that anytime the motor amperage draw exceeds 400 amps, the PLC 50 will shut off the necessary pins (circuits) to bring the vehicle safely to a stop until the unsafe condition is remedied. In the same embodiment, a variable preprogramming sequence 130 may be provided as shown in FIG. 12 (12A-12C) to offer “on” or “off” outputs from the PLC 50 through pins 1 through 10 into the corresponding output circuits to vary the speed of the vehicle by engaging or disengaging the linear actuator 42 of the variable speed transmission 20 according to the variable inputs fed into the PLC 50 based on the motive condition of the vehicle at any given MPH between the stopped condition and, for example, a top speed of 90 MPH for the vehicle.

In operation, the PLC 50 provides multiple functions. The PLC 50 is preprogrammed and mounted in the vehicle 60. The PLC 50 includes a plurality of terminal connections that may be connected to, for example, the following within the low voltage motor control subsystem 112 to monitor different conditions:

1. A positive and negative to a digital speedometer's LCD wires;

2. A positive and negative to a digital odometer's LCD wires;

3. A positive to a battery case blower warning light;

4. A positive and negative to a potentiometer controller;

5. A ground to the vehicle frame and established low voltage system ground;

6. A positive power feed from an ignition switch through a main fuse of the low voltage motor control subsystem 112;

7. A positive wire to a low voltage accessory system battery pack “low voltage” warning light;

8. A positive wire to a low voltage accessory system battery pack “high voltage” warning light;

9. A positive wire to a “motor temperature” warning light;

10. A positive wire to a “low voltage” warning light; of the high voltage subsystem 110;

11. A positive wire to a “high voltage” warning light of the high voltage subsystem 110;

12. A positive wire to a “motor temperature” sending unit;

13. A positive wire to a tachometer and motor limit control unit;

14. A positive wire to a battery case vent blower motor's positive terminal;

15. A positive wire to the electromagnetic clutch 66 of the momentum recharging system 90;

16. A positive and negative wire to the linear actuator control unit 116;

17. A positive and negative wire to a low voltage accessory system's digital voltage meter LCD wiring;

18. A positive and negative wire to a digital amperage meter LCD wiring of the high voltage subsystem 110;

19. A positive and negative wire to a digital voltage meter LCD wiring of the high voltage subsystem 110;

20. A positive and negative wire to a GPS system transceiver; and

21. A positive wire to a “reverse” terminal of the single pole double throw reverse contactor switch to switch the VSD system 20 between a forward and reverse operating mode.

In a vehicle application, when an ignition switch is turned to the “on” position, the PLC 50 is also turned on, and at which time the PLC 50 begins monitoring input readings, for example, from a speedometer 114 (shown in FIG. 10), an ohm meter, a high voltage motor amperage draw, a battery voltage of the high voltage subsystem 110, a battery voltage of the low voltage motor control subsystem 112, the motor temperature, and the battery case vent blower motor terminal voltage, among others. According to the preprogrammed variable formulas and preprogrammed finite inputs, the PLC 50 recalculates control information and sets and resets the outputs sequentially at a preset repetitive rate according to the recalculated results. It should be noted that with respect to the speedometer reading, nothing is calculated during acceleration. Also, it should be noted that the programming of the various conditions, operation conditions, control functions, etc. may be changed or modified as desired or needed, for example, based on the vehicle.

Further, in operation, and with respect to the ohm input reading from the potentiometer 120, the PLC 50 outputs a rate of movement to the linear actuator 42 until the position of the linear actuator 42 equals the ohm reading of a potentiometer 120 identifying a preprogrammed finite reading of ohms at that segmented position of the linear actuator 42. The linear actuator 42 adjusts the pitch ratios of the variable speed drive pulleys 24, varying the rate of speed of the vehicle 60. For example, if the preprogrammed finite ohms reading for the linear actuator 42 to move the vehicle at twenty-five MPH equals 1333.4 to 1388.9, then as long as a drivers foot remains on a foot feed 121 (e.g., foot pedal) and a control arm of the foot feed moves the potentiometer maintaining a reading between 1333.4 and 1388.9, the linear actuator 42 moves at the specified rate of acceleration until the linear actuator 42 reaches a 25^{th} position (e.g., Y=25 in FIG. 10), resulting in the variable speed pulleys 24 moving to a position adjusting the pitch ratio to bring the vehicle 60 to a speed of 25 MPH.

The rate of movement can be adjusted faster or slower according to how far the foot feed 121 is depressed for any given reading in ohms. For example, if a person steps on the foot feed 121 and the ohms reading is between 1,001 and 2,000, a preset rate of acceleration of 0.444 seconds per linear actuator segment movement may be suitable and preferred, or if a person steps on the foot feed 121 and the resulting ohms reading is between 4,001 and 5,000 then a rate of acceleration of 0.111 seconds per linear actuator segment movement may be suitable and preferred. Each segment of linear actuator movement may represent a one mile per hour increase in vehicle speed, until the vehicle speed input by a digital speedometer equals the preprogrammed segment of ohms reading, at which time the linear actuator 42 will remain in that position until the PLC 50 sends another reading to either move further (accelerating further) or regress creating a deceleration condition for the vehicle 60. Upon regression of ohms past a preprogrammed limit, the PLC 50 communicates a new reading to the linear actuator 42 (and variable speed drive pulleys 24) equal to the speed of the vehicle 60 during the deceleration process (in miles per hour from the digital speedometer) such that the position of the linear actuator 42 (and variable speed drive pulleys 24) always equals the miles per hour of the vehicle 60. Accordingly, in the event of reacceleration, no difference exists between the linear actuator position (and variable speed drive pulleys) and the pitch ratio of the motor verses the axle RPMs, thereby reducing the likelihood of creating a “jumping” or “skipping” effect in the drive system and an intensified or de-intensified amperage draw.

Referring again to FIG. 8, upon regression of ohms past a preprogrammed limit, the PLC 50 also may be preprogrammed to turn off the tachometer/motor limit control unit, thereby turning off a main contactor of the high voltage subsystem 110, the motor 22, and the motor electromagnetic clutch 66, as well as turn on an electromagnetic clutch 89 momentum recharging system, thereby engaging a shaft 93 that turns, for example, a plurality of regenerative alternators 91. This engagement and turning of the shaft 93, provides power back into, for example, both high voltage and low voltage battery packs of the high voltage subsystem 110 and low voltage motor control subsystem 112 each time deceleration occurs.

Thus, the input reading from the potentiometer 120 determines the rate of acceleration and the leveling off point of the same. For example, once cruising at any given speed, the potentiometer 120 and the speedometer readings determine whether to continue moving at that speed within a preset range of variance, or once outside and higher than that preset range, to accelerate again, or once outside and lower than that preset range, to decelerate again. It should be noted that the rate of regression of the variable speed pulleys 24 and linear actuator 42 is determined by the drop in MPH reading until the MPH reading equals the ohms reading equivalent to the potentiometer 120 (once the foot feed 121 has been released to any given degree).

The PLC 50 also may monitor a drive motor amperage draw, if the motor amperage draw is less than a preprogrammed limit. The PLC 50 turns on power to the tachometer/motor limit control unit terminal, thereby turning on and keeping on the high voltage main contactor and the drive motor electromagnetic clutch 66, if the foot feed 121 is depressed and all tachometer/motor limit control unit conditions are met. This condition results in turning on the drive motor 22 and moving the vehicle 60. If the motor amperage draw exceeds a preprogrammed limit, then the PLC 50 turns off the power to the tachometer/motor limit unit terminal, thereby shutting down the VSD system 20, and providing no power to the vehicle 60 to move any further until the amperage draw drops below the preprogrammed limit.

It should be noted that the tachometer/motor limit control unit may operate in conjunction with an analog tachometer, a pulsing piezo buzzer, and an tachometer sensor unit provided in any known manner. A ground wired is also provided to the tachometer/motor limit control unit that is connected to ground of the low voltage motor control subsystem 112 and a power feed wire from the PLC 50 that actives the tachometer/motor limit control unit when required. The tachometer/motor limit control unit also monitors the output of the tachometer sensor units indicating the RPM of the motor 22 and is preprogrammed to shut the motor 22 off if the RPM reading exceeds a preset limit, or if the feed power to the motor 22 remains at or below the preset limit. This control may be provided through an output wire of the tachometer/motor limit control unit that is connected to a common terminal of the potentiometer 120, with a “closed” terminal of the potentiometer connected to the positive wires of the drive motor electromagnetic clutch 66 and the main contactor of the high voltage subsystem 110. When the proper conditions are met within the PLC 50, the PLC 50 activates the tachometer/motor limit control unit, which in turn activates the main contactor of the high voltage subsystem 110 once the foot feed 121 is depressed. This then turns on the drive motor 22 and also activates the motor electromagnetic clutch 66, thereby engaging the variable speed drive pulleys 24, and in turn activating movement of the entire drive train and moving the vehicle 60.

Various other controls or components may be provided. For example, a reverser contactor may be provided in connection with a single pole, double throw switch within the low voltage motor control subsystem 112. The single pole, double throw switch is connected to terminals of the reverser contactor, which when in an “on” position, allows the motor 22 to move in one direction (e.g., a clockwise direction) moving the vehicle 60, for example in a forward direct, and when switched to the opposing “on” position, switches the feed of power through the reverse contactor from an S1 to S2 terminal located on the motor 22, reversing the polarity and direction of rotation to another opposing direction (e.g., in a counterclockwise direction) allowing the motor 22 and vehicle 60 to move in reverse. Also connected to a positive “reverse” terminal of the single pole, double throw switch is a terminal of the PLC 50, such when the single pole double throw switch is in the “reverse” (on) position, the PLC 50 is preprogrammed to limit the positions in which the linear actuator 42, for example, to five segments, thereby limiting the speed of the vehicle 60 to five MPH. Also connected to the positive “reverse” terminal of the single pole, double throw switches may be a signal flashing relay (flasher). The opposing positive terminal of the flasher is wired to a light that may include the word “reverse” or “R” for reverse, for example provided on the light cover. The negative terminal of the light is connected to the system frame for a ground. The light may be of any color, for example, red, such that when the switch is toggled to the reverse position, a red flashing warning light illuminates the word reverse as it flashes, alerting the driver to the fact that if he/she steps on the foot feed 121 the vehicle 60 will move in a reverse direction. Wired to the opposing “on” terminal of the single pole, double throw switch wiring is another light that may include the word “drive” or “forward” on the light cover. The light cover may be of any color, for example, green, such that when the single pole, double throw switch is toggled to the forward (on) position, the green light illuminates the word “drive” or “forward”, alerting the driver to the fact that if he/she steps on the foot feed 121 the vehicle 60 will move in the forward direction.

The electric motor 22 used to power the VSD system 20 and move the vehicle 60, may include a series wound electric motors that are allowed to run near or at maximum RPMs continuously, providing only a variation in RPMs per amount of torque applied to the VSD system 20 at the output shaft of the motor 22, thereby allowing the VSD system 20 to operate efficiently according to design. For example, the positive terminal (A1) of the motor 22 is connected to a shunt, with the shunt connected to an emergency shut off switch. The emergency shut off switch is connected to a DC circuit breaker, and the DC circuit breaker is connected to a battery pack positive terminal. The emergency shut-off is physically located within the reach of the driver and functions, for example, as an emergency shut-off in case of an accident, fire, etc. The negative (A2) terminal of the motor 22 is connected to the reverse contactor and the reverse contactor is connected a negative terminal of the battery pack. The S1 terminal of the motor 22 is, for example, connected to the (R) reverse terminal of the reverse contactor and the S2 terminal of the motor 22 is connected to the reverse contactor's (F) forward terminal. The low voltage terminals are connected to a digital amperage meter. The function of the shunt is to proportion the current to an acceptable level for the amperage meter to handle without burning out the amperage meter circuit.

It should be noted that the function of the main contactor is to connect the high voltage electrical components of the system to the high voltage battery subsystem 110 once the ignition switch is turned on, the foot feed 121 is depressed, and the Tachometer Control and RPM Limiter reads the motor RPMs and calculates that the motor RPMs are within an acceptable range. If the motor RPMs exceed a preprogrammed limit, the Tachometer Control and RPM Limiter disconnects the contacts in the main contactor until the RPMs of the motor 22 drop to an acceptable level reading, at which time power is provided to the main contactor and the contacts of the main contactor reconnect, thereby providing power through the shunt and to the motor again.

It should be noted that a gear or pulley may be provided and adaptively coupled a main output shaft 23 of the motor 22 and an auxiliary shaft is not used, but may be used to power, for example, the power steering pump 78, etc.

The vehicle drive system may also include, for example, a separate battery pack for the drive motor and a separate battery pack for the low voltage motor control system 112 and vehicle accessories as described above. Thus, the high voltage subsystem 110 for the drive motor and the low voltage motor control subsystem 112 for the drive motor system controls and customary vehicle accessories may be separately powered in existing vehicle conversions, while in new vehicle production it may be advantageous and desirable to provide the low voltage motor control subsystem 112 and the vehicle electrical accessory subsystem 114 using one low voltage battery pack. It should be noted that the low voltage battery pack may function, for example, to receive, store, and supply the required power to the low voltage motor control subsystem 112.

Other components that may be provided include, for example, a motor temperature sensing unit that is adaptively mounted to the side of the motor 22 to sense the motor temperature. The positive terminal of the motor temperature sending unit is connected to the PLC 50 to communicate temperature readings to the PLC 50 for processing as described herein. The negative terminal is connected, for example, to the frame of the system for a ground.

A digital voltage meter also may be provided that is compatible with the high voltage subsystem 110 and is connected between the positive wiring and the negative wiring of the high voltage battery pack. The digital voltage meter may include a Liquid Crystal Display (LCD) that is connected to the PLC 50. The digital voltage meter also may be connected to a battery of the low voltage motor control subsystem 112. The digital voltage further may be connected to low voltage accessories.

A digital amperage meter further may be provided that is compatible with the high voltage subsystem 110 and that is connected to shunt of the high voltage subsystem 110. The digital amperage meter may include an LCD that is connected to the PLC 50. The digital amperage meter also may be connected to a battery of the low voltage motor control subsystem 112 or to a low voltage accessories system.

A circuit breaker also may be provided with the low voltage motor control subsystem and connected to the low voltage accessory system. The circuit breaker is configured to break the circuit between the low voltage system battery pack and the low voltage accessory system wiring in case of, for example, an amperage overload.

A main fuse may be provided with the low voltage motor control subsystem 110 and connected micro switches mounted on the potentiometer 120. The main fuse is configured to break the circuit between the low voltage system battery pack and the low voltage motor control subsystem 112 in case of, for example, an amperage overload.

A “normally closed” micro switch connected to a tachometer of the low voltage motor control subsystem 112 and the motor limit control unit and opposingly connected to the low voltage circuit of the high voltage main contactor and the motor electromagnetic clutch 66 also may be provided. The “normally closed” micro switch is configured to be adaptably mounted on the potentiometer 120 of the low voltage motor control subsystem 112. The micro switch provides, for example, safety functions. For example, the micro switch is provided in an “open” (off) position while the potentiometer 120 is in an “at rest” position with a low ohm reading and is engaged into a “normally closed” (on) position once the driver steps on the foot feed 121 and moves the control arm of the potentiometer 120, completing the circuit between both the high voltage subsystem 110 and the low voltage motor control subsystem 112, and more particularly, the tachometer and motor limit control and electromagnetic clutch terminals of the low voltage motor control subsystem 112. The micro switch operates to engage the high voltage side of both components, activating the drive motor 22 (of the high voltage subsystem 110) and coupling the mechanical components of the VSD system 20 to the drive motor 22, and setting the vehicle 60 in motion if, for example, all settings are met within specified preprogrammed limits in the PLC 50.

It further should be noted that the various components may monitor different conditions. For example, the PLC 50 may monitor the voltage of both the high and low voltage systems battery packs, and if the voltage of either is too high, the PLC 50 turns on the respective “high voltage” light. If the voltage of either is too low, the PLC 50 turns on the respective “low voltage” light until either situation is remedied. Further, the PLC 50 also may monitor the voltage at the battery case vent blower fans. If for any reason the fuse is blown and/or the blower looses power a “blower” warning light is turned on by the PLC 50 until voltage to the blower is restored. The PLC 50 also may monitor the motor temperature from the motor temperature sensing unit, if the motor temperature is below a preset limit. The PLC 50 maintains the analog signal to the “Motor Temp” light “off”, but if the motor temperature exceeds a preset limit then the PLC 50 turns on power to the “Motor Temp” warning light.

The PLC also may monitor and provide the odometer reading of the vehicle 60 to an optional Global Positioning System (GPS) system transceiver, with the continuously updated digital reading being transmitted to the PLC 50 at a preprogrammed time intervals with the same reading being retransmitted from the PLC 50 to the GPS transceiver located within the vehicle 60, allowing for a remote mileage reading via satellite communications at any given time. This information also may be used, for example, to calculate subsequent billing of the vehicle owner for federal, state, local, and any applicable road taxes. With the same GPS system that includes the ability to remotely disable the vehicle, further travel of the vehicle may be prevented, for example, if the road tax due is not paid within a predetermined amount of time.

Additional or different warning indications and lights also may be provided. For example, the following set of system error “warning lights” may be provided with the positive terminal of each light connected to the PLC 50 terminal and the negative terminals connected to system ground: a high voltage system “high” and “low” voltage warning light, a “motor temperature” warning light, a low voltage system “high” and “low” voltage warning light, and a battery case vent “blower” warning light. In operation, if the voltage of the high voltage subsystem 110 exceeds a preprogrammed limit, the PLC 50 sends an analog signal to the high voltage system “high” voltage warning light, turning the high voltage system “high” voltage warning light on to alert the driver of that condition. If the voltage of the high voltage subsystem 110 becomes lower than a preprogrammed limit, the PLC 50 will send an analog signal to the high voltage system's “low” voltage warning light, turning high voltage system's “low” voltage warning light on to alert the driver of that condition. If the high voltage system's motor temperature becomes higher that a preprogrammed limit, the PLC will send an analog signal to the high voltage system's “motor temperature” warning light, turning the high voltage system's “motor temperature” warning light on to alert the driver of that fact. If the voltage of the low voltage motor control subsystem 112 exceeds a preprogrammed limit, the PLC 50 will send an analog signal to the low voltage motor control system's “high” voltage warning light, turning the low voltage motor control system's “high” voltage warning light on to alert the driver of that condition. If the voltage of the low voltage motor control subsystem 112 becomes lower that a preprogrammed limit, the PLC 50 will send an analog signal to the low voltage motor control system's “low” voltage warning light, turning the low voltage motor control system's “low” voltage warning light on to alert the driver of that condition. If the battery case vent blower motor of the low voltage motor control subsystem 112 looses power, the PLC 50 will send an analog signal to the low voltage motor control system's battery case vent's “blower” warning light, turning on the low voltage motor control system's battery case vent's “blower” warning light to alert the driver of that condition.

The various components within a vehicle 60 having the VSD system 20 may be interconnected and controlled in any known manner and as described herein. The system components may include: an electronic speedometer/odometer control unit, a LCD speedometer display unit, a LCD odometer display unit, and a speedometer sensing unit with junctions of the wires between the LCD speedometer display unit, the LCD odometer display unit, and the electronic speedometer/odometer control unit being wired to the respective terminals of the PLC 50 for monitoring and/or control. For example, the digital speedometer readout may be used to calculate the deceleration rate of the vehicle as previously described, while the odometer reading may be communicated through the PLC 50 to the GPS transceiver unit as described herein.

While particular embodiments of the invention have been shown and described, it will be obvious to those skilled in the art that changes and modifications may be made without departing from the invention in its broader aspects. For example, the VSD system 20 may be constructed to use a radial leverage system with the linkage connecting the throw-out bearings to the main control arm with the linkage pivoting on a central pin. More than one linear actuator may be used, with control arms being independent of each other and/or a casing fabricated to insert the bearings therein, supporting the VSD system 20 shafts. A chain and sprocket system may be used between non-variable shaft connections, such as from the motor through the closest variable speed pulley shaft and from the final variable speed pulley shaft to the axle. It is also apparent that the physical size of the system, including but not limited to, pitch ratio's between variable speed pulleys, can be increased or decreased and applied to different applications such as golf carts, neighborhood electric vehicles (NEV's), semi tractors, or even locomotives by increasing or decreasing the diameter of variable speed pulleys, etc. For example, the VSD system 20 may be implemented in connection with a locomotive train 128 as shown in FIGS. 13 and 14. In this embodiment, stages of the VSD system 20 are engaged and disengaged as needed or desired using a plurality of clutches 130. Thus, as the speed of the locomotive train 128 increases or decreases, stages of the VSD system, and in particular, pairs of opposing variable speed drive pulleys 24 may be engaged and/or disengaged.

Additional components also may be included. For example, an electronic tachometer eye may be provided to monitor the RPMs of one or more of the variable speed drive pulleys 24 of the VSD system. Additionally, another electromagnetic clutch may be provided as a safety clutch.

Thus, various embodiments of the invention provide a substantial gain in pitch/torque ratios in an EV that result in a substantial reduction in the amperage drawn and needed to motivate an EV.

While the invention has been described in terms of various specific embodiments, those skilled in the art will recognize that the various embodiments of the invention can be practiced with modification within the spirit and scope of the claims.

What is claimed is:

1. A variable speed transmission comprising:
a first variable speed drive pulley; and
a second variable speed drive pulley, wherein a pitch diameter of the first variable speed drive pulley and the second variable speed drive pulley are configured in an opposed arrangement.

2. A variable speed transmission in accordance with claim 1 wherein at least one of the first variable speed drive pulley and the second variable speed drive pulley comprise an idler pulley.

3. A variable speed transmission in accordance with claim 1 wherein the first variable speed pulley and the second variable speed pulley are provided in an inline arrangement.

4. A variable speed transmission in accordance with claim 1 wherein at least one of the first variable speed drive pulley and the second variable speed drive pulley comprises a double variable speed pulley.

5. A variable speed transmission in accordance with claim 1 wherein one or more of the first variable speed drive pulley and the second variable speed drive pulley are adaptably coupled to a shaft in sets.

6. A variable speed transmission in accordance with claim 5 wherein at least one of the first variable speed pulley and the second variable speed pulley comprise an idler pulley set.

7. A variable speed transmission in accordance with claim 5 wherein a first variable speed pulley set and a second variable speed pulley set are provided in an inline arrangement.

8. A variable speed transmission in accordance with claim 5 wherein at least one of a first variable speed pulley set and a second variable speed pulley set comprise a set of double variable speed pulleys.

9. A variable speed transmission in accordance with claim 1 wherein the first and second variable speed pulleys define a first opposing pulley pair and further comprising a second opposing pulley pair wherein the second variable speed pulley of the first opposing pulley pair is coupled to a shaft with a first variable speed pulley of the second opposing pulley pair.

10. A variable speed transmission in accordance with claim 9 further comprising at least one set of opposing pulley pairs.

11. A variable speed transmission in accordance with claim 1 further comprising a variable speed control pulley at one end of the opposed arrangement.

12. A variable speed transmission in accordance with claim 11 further comprising a pressurized variable speed slave pulley at an opposite end of the opposed arrangement with the first and second variable speed pulleys between the control pulley and pressurized variable slave pulley.

13. A variable speed transmission in accordance with claim 12 wherein the pressurized variable speed slave pulley comprises a spring loaded pulley.

14. A variable speed transmission in accordance with claim 12 wherein the pressurized variable speed slave pulley is spring loaded in a “closed” configuration.

15. A variable speed transmission in accordance with claim 12 wherein the pressure of the pressurized variable slave speed pulley comprises one of a pneumatic, hydraulic, electromechanical and mechanically spring loaded means.

16. A variable speed transmission in accordance with claim 1 further comprising a linear actuator configured to control the multiple configurations of the first and second variable speed pulleys.

17. A variable speed transmission in accordance with claim 16 further comprising a linkage connection between the linear actuator and a control pulley for controlling the pitch diameter of the multiple configurations of the first and second variable speed pulleys.

18. A variable speed transmission in accordance with claim 16 further comprised of a controller configured to control the linear actuator.

19. A variable speed transmission in accordance with claim 18 wherein the controller is a programmable logic computer (PLC).

20. A variable speed transmission in accordance with claim 18 wherein at least one controller input is determined and preprogrammable.

21. A variable speed transmission in accordance with claim 1 wherein the first variable speed drive pulley and the second variable speed drive pulley are configured to operate in one of a motive and non-motive application.

22. A variable speed transmission in accordance with claim 1 further comprising a power source.

23. A variable speed transmission in accordance with claim 22 wherein the power source comprises at least one of (i) a fossil fueled engine, (ii) natural power including at least one of (a) water, (b) gas and (c) wind, (iii) an electric motor, (iv) human power, and (v) animal power.

24. A variable speed transmission in accordance with claim 22 wherein the power source comprises an electric motor.

25. A variable speed transmission in accordance with claim 22 further comprising a power supply providing power to the power source.

26. A variable speed transmission in accordance with claim 1 further comprising an electromagnetic clutch configured to one of engage and disengage the first variable speed drive pulley and the second variable speed drive pulley from a power source.

27. A variable speed transmission in accordance with claim 1 further comprising an electromagnetic clutch configured to one of engage and disengage the first variable speed drive pulley and the second variable speed drive pulley from a power regeneration system.

28. A variable speed transmission in accordance with claim 1 wherein the first variable speed drive pulley and the second variable speed drive pulley are configured to provide gear/torque ratios that are exponentially multiplied.

29. A variable speed transmission comprising:
a first pulley;
a second pulley; and
a plurality of variable speed drive pulleys between the first and second pulleys.

30. A variable speed transmission in accordance with claim 29 wherein at least one of the first and second pulleys are variable speed drive pulleys.

31. A variable speed transmission in accordance with claim 29 wherein at least one of the first and second pulleys are solid pulleys.

32. A variable speed transmission comprising:
a first variable speed drive pulley;
a second variable speed drive pulley; and
a third variable speed drive pulley.
